(19) United States
(12) Patent Application Publication
(10) Pub. No.: US 2023/0279886 A1
(43) Pub. Date: Sep. 7, 2023

(54) CONNECTING SYSTEM BETWEEN COMPONENTS OF A PIECE OF FURNITURE AND PIECE OF FURNITURE COMPRISING SAID SYSTEM

(71) Applicant: INTELLIGENT FIXINGS LIMITED, London (GB)

(72) Inventor: Brady Luke THOMSON, London (GB)

(21) Appl. No.: 18/008,338

(22) PCT Filed: Jun. 3, 2021
(86) PCT No.: PCT/IB2021/054865

§ 371 Date: Dec. 5, 2022

(30) Foreign Application Priority Data
Jun. 5, 2020 (IT) 102020000013438

(51) Int. Cl. F16B 12/22; F16B 12/20

(52) U.S. Cl. CPC F16B 12/22; F16B 12/2063

(57) ABSTRACT

A connecting system between components of a piece of furniture, includes a pin having a base, a stem departing from said base along an insertion direction and an enlarged portion and a slot made in a second component of a piece of furniture, extending along a tightening direction transverse to the insertion direction and sized to house inside the enlarged portion of the pin, wherein the pin is insertable inside the slot along the insertion direction in correspondence with the insertion portion and is movable inside the slot, along the tightening direction, towards a tightening position. The system includes an anti-sliding device configured to prevent the sliding of the pin inside the slot when in the tightening position.

The present invention relates to a connecting system between components of a piece of furniture and a method for manufacturing said system.

In the field of furniture production, and more generally of furnishing elements, the use of connecting devices to connect the different components of furniture and tighten them is known, both in correspondence with connecting angles between elements in the form of panels and in fixing crosspieces, shelves or other elements, in order to assemble the piece of furniture and/or equip it with specific accessories.

To date, two types of systems are mainly known: interlocking or expanding.

The interlocking systems are of particular interest for this discussion, which generally include the adoption of a first element, equipped with a slot, and a second component, equipped with a pin, such as to couple following the insertion and subsequent sliding of the pin in the slot.

The slot is usually shaped like a “lock” and provided with a wider insertion portion and a tightening portion, defining an undercut such as to retain the pin therein, avoiding the detachment between the components.

To date, however, such systems are little used and exploited on the market, as the connection they define is unreliable or hardly economical from a production point of view, requiring in most cases inserts for both the male and female components of the coupling.

Solutions also exist which include a direct coupling of the pin with the chipboard/core of the wooden component, which is previously milled so as to avoid the need to provide expensive and difficult to assemble inserts.

Examples of such systems can be found within numerous patent documents, such as DE8708112, US20140059829 and EP3212945.

All the documents listed above show fixing systems in which the female component of the coupling is obtained by a processing in the side of the panel such as to create an oblong slot equipped, along the development thereof, with at least one pair of sub-panels useful to retain a suitably shaped pin therein.

Unfortunately, in practice such systems are not progressive in the sliding of the pin inside the slot, making the movement difficult during assembly or causing, on the contrary, a poor seal of the coupling. In other words, the coupling tolerance in such systems is very limited, leading to inaccurate systems having tightening difficulties or loose couplings.

To overcome such a problem, document EP3212945 includes the presence of undulated pins, shaped so that in the tightening position each groove of the pin is coupled to a corresponding protrusion of the slot and vice versa.

By virtue of this multiplication of interlocks, the seal of the coupling is undoubtedly better, but still has substantial risks of reversal.

Precisely because of the possibility of decoupling between the two components, to date systems of this type find exclusive application in components which require at least two pin/slot couplings and which, preferably, also require the coupling of a third component adapted to prevent sliding in the release direction.

Typical application examples are precisely the side panels of a piece of furniture, in which the bottom (or top) walls are used as an abutment adapted to prevent decoupling.

This clearly significantly limits the spread of these connecting systems, reducing their appeal to furniture manufacturers and preventing their spread.

The object of the present invention is therefore to provide a connecting system for components of a piece of furniture and a manufacturing method of said system which overcome the drawbacks related to the above-mentioned known art.

In particular, among the objects of the present invention is to provide a connecting system for components of a piece of furniture which does not require mounting tools and ensures a high seal.

A further object of the present invention is to provide a connecting system for components of a piece of furniture which is easy to assemble and disassemble.

Further, an object of the present invention is also to provide a connecting system for components of a highly versatile and secure piece of furniture, capable of finding application in a multitude of couplings.

Said objects are achieved by a connecting system between components of a piece of furniture having the features of one or more of the following claims 1 to 9, as well as by a piece of furniture having the features of claim 10.

In particular, said objects are achieved by a connecting system between components of a piece of furniture comprising a slot, made in one component of the piece of furniture, and a pin fixable or integrated with the other component and slidably insertable into the slot.

The pin has a base fixable or integrated to the first component of the piece of furniture, a stem departing from said base along an insertion direction (of the pin in the slot) and an enlarged portion having a width greater than said stem to define a shoulder facing said first component (i.e., facing said base). Preferably, the enlarged portion is defined by a head of the pin.

The slot is, as said, made in the second component of a piece of furniture.

Such a slot extends along a tightening direction transverse to the insertion direction and is sized to house inside the enlarged portion of the pin.

In particular, the slot has an insertion portion equipped with an enlarged insertion section such as to allow the introduction of the enlarged portion of the pin into the slot along the insertion direction.

The insertion portion is preferably of constant section, substantially corresponding to that of the enlarged portion of the pin.

The slot further comprises a retaining portion, provided with at least one abutment shoulder (preferably two) extending along said tightening direction and shaped to prevent the exit of the enlarged portion of the pin along the insertion direction.

In other words, the abutment shoulder defines an undercut inside the slot such as to abut the shoulder of the enlarged portion, preventing the exit thereof.

Therefore, the slot is preferably shaped as a keyhole slot and has:
an “outer” portion with variable cross-section between an enlarged portion corresponding to the insertion portion and a narrow portion corresponding to the retaining portion
an “inner”, deeper portion having a substantially constant width and approximately corresponding to that of said enlarged portion of the pin.

In use, the pin is therefore insertable into the slot along said insertion direction, in correspondence with said insertion portion, and is movable inside the slot, along the tightening direction, towards a tightening position.

More precisely, the pin can be inserted into the slot until it reaches an engaging position, from which it is slidable in the slot along the tightening direction.

According to an aspect of the present invention, the abutment shoulder comprises a sliding surface for shouldering the enlarged portion of the pin.

Preferably, the sliding surface has a guide section and a fixing section.

Preferably, the guide section is proximal (more preferably adjacent) to the slot insertion portion and defines an angle with both said insertion direction and said tightening direction.

The fixing section is instead distal to the insertion portion and is aligned with said tightening direction.

Preferably, therefore, the guide section is inclined with respect to both directions so as to define a tightening ramp which guides the pin into the slot easily, while the tightening section reduces its angle so as to favour the maintenance of the tightening position by the pin.

Preferably, the guide section of the sliding surface extends between a first end, proximal to said insertion portion, and a second end, distal from the insertion portion.

Preferably, the abutment shoulder has an increasing thickness between at least a first value, in correspondence with said first end of the guide section, and at least a second value, in correspondence with said second end of the guide section.

Preferably, moreover, the slot has a bottom wall arranged respectively at a first and a second distance from the first and the second end of the guide section, in which the first distance is greater than the second distance.

In other words, the height (i.e., distance between the sliding surface and the bottom wall) of the slot in the tightening portion is not constant, but tends to decrease in the guide section, facilitating movement from the engagement position to the tightening position and at the same time providing resistance to movement in the opposite direction.

Preferably, the guide section of the sliding surface forms an angle between 10° and 30°, preferably about 15°, with said bottom wall.

Preferably, said insertion direction and said tightening direction are orthogonal to one another.

It should be noted that the second component of the piece of furniture is preferably shaped like a wooden panel, more preferably with a structure in MDF, chipboard or veneered.

Advantageously, the slot is therefore made directly on the component of the piece of furniture, without requiring additional elements or hardware and for the benefit of the user.

According to a further aspect of the invention, complementary or alterative to the above aspects described heretofore, the system comprises an anti-sliding device configured to prevent the sliding of the pin inside the slot when in the tightening position.

Preferably, the anti-sliding device comprises a blocking element connected to said pin base and protruding next to said pin.

Said blocking element is shaped to engage in a hole (or in the slot insertion portion) of said second component when said pin is in the tightening position.

Advantageously, thereby, the stability of the connection is further strengthened, facilitating its use also in single-pin applications.

Typically, in fact, in the connection of two panels there are multiple pins and multiple corresponding slots, but in other systems (e.g., tube support) it is advantageous to have only one, which makes the solution described here particularly advantageous.

Preferably, the anti-sliding device has an elastically deformable bracket (or lip) which connects the base of the pin and the blocking element to each other.

More preferably, the elastically deformable bracket is configured to allow an oscillation of the blocking element, with respect to the pin, around an axis orthogonal to the insertion direction.

Advantageously, the elasticity of the bracket allows it to be inflected allowing the blocking element to slide on the second component of the piece of furniture (in particular on a flat face thereof) until it engages in the hole (or in the slot insertion portion) when the pin reaches the tightening position.

Preferably, the central axis of the pin is aligned with a central axis of the blocking element along the tightening direction.

It should be noted that, preferably, the slot defines therein a stroke of the pin along the tightening direction, corresponding to a distance between a central axis of the insertion portion and a central axis of the pin in the tightening position.

Preferably, the central axis of the pin is positioned at a distance from a central axis of the blocking element which is greater with respect to said stroke.

According to a first alternative, the hole is made in the second component of the piece of furniture is flanked by the slot.

More preferably, the hole is aligned with the slot along the tightening direction, in which said slot insertion portion is interposed between said sliding portion and said hole.

Preferably, the blocking element is defined by a tooth protruding from the bracket and provided with at least one abutment side orthogonal to the tightening direction in order to prevent the movement of the pin when engaged in said hole or in said slot insertion portion.

Advantageously, this results in a simple, cost-effective and safe connecting system.

An object of the present invention is also a piece of furniture, comprising a first and a second component, in which the second component (preferably a panel) has a flat face.

According to such an aspect of the invention, the piece of furniture comprises a connecting system between said first and said second component having one or more of the features described heretofore, in which the pin is fixed to said first component, the slot is made in said second component and the enlarged portion of the pin is placed in the slot in correspondence with the tightening position.

A further object of the present invention is a manufacturing method of a component of a piece of furniture.

Such a method, preferably but not exclusively feasible for making the slot described heretofore, comprises the steps of preparing a component of a piece of furniture having a flat face and a milling tool provided with a cutting head.

The cutting head preferably has a stem and an end portion which is wider than said stem, such as to define a shoulder.

The milling tool is then moved along a processing path to make the slot in the flat face of the component.

According to an aspect of the invention, the processing path comprises:
a first section, transverse to said flat face, in which the milling tool pierces the flat face of the component along a drilling axis up to a first working position in which said end portion is positioned at a first depth;
a second section, transverse to the first section, in which the milling tool moves to a second working position, in which the end portion is misaligned with respect to said drilling axis and placed at a second depth, greater than the first depth;
a third section, transverse to the first section, in which the milling tool moves to a third working position in which the distal end portion from the first working position with respect to the second working position.

Advantageously, thereby, an inclined ramp (or chute) is made which, in use, facilitates the insertion of a fixing pin in the slot.

Preferably, moreover, in the third working position, the end portion of the milling tool is placed at said second depth.

Preferably, the processing path comprises a fourth section in which the milling tool moves from the third working position to a fourth working position in which the end portion is aligned with said drilling axis and positioned at said second depth.

These and other features with the related advantages, will become more apparent from the following exemplary, therefore non-limiting, description of a preferred, therefore not exclusive, embodiment of a connecting system between components of a piece of furniture and a piece of furniture, as well as a method for processing a component of a piece of furniture and a method for manufacturing a connecting system between two components of a piece of furniture, as illustrated in the attached figures, in which:

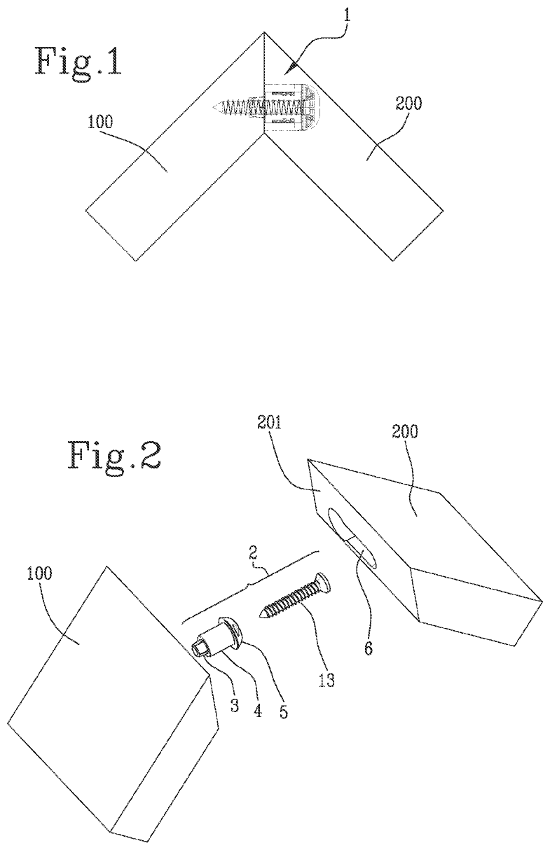

FIG. 1 shows a view of a connecting system for components of a piece of furniture according to a first embodiment of the present invention, with some parts of the piece of furniture transparent in order to highlight others;

FIG. 2 shows a first exploded perspective view of the system in FIG. 1;

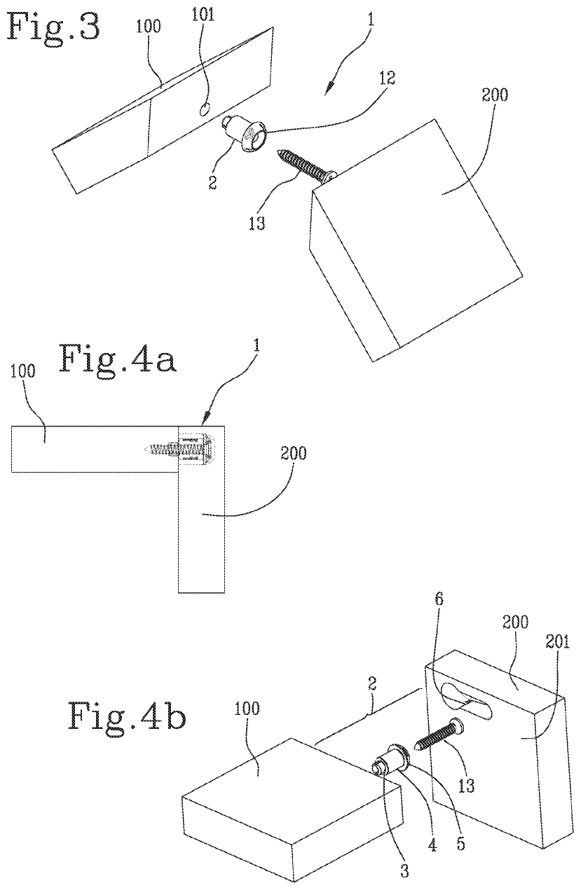

FIG. 3 shows a second exploded perspective view of the system in FIG. 1

FIG. 4a shows a view of a connecting system for components of a piece of furniture according to a second embodiment of the present invention, with some parts of the piece of furniture transparent in order to highlight others;

FIG. 4b shows an exploded perspective view of the system in FIG. 4a;

FIG. 5a shows a view of a connecting system for components of a piece of furniture according to a third embodiment of the present invention, with some parts of the piece of furniture transparent in order to highlight others;

FIG. 5b shows an exploded perspective view of the system in FIG. 5a;

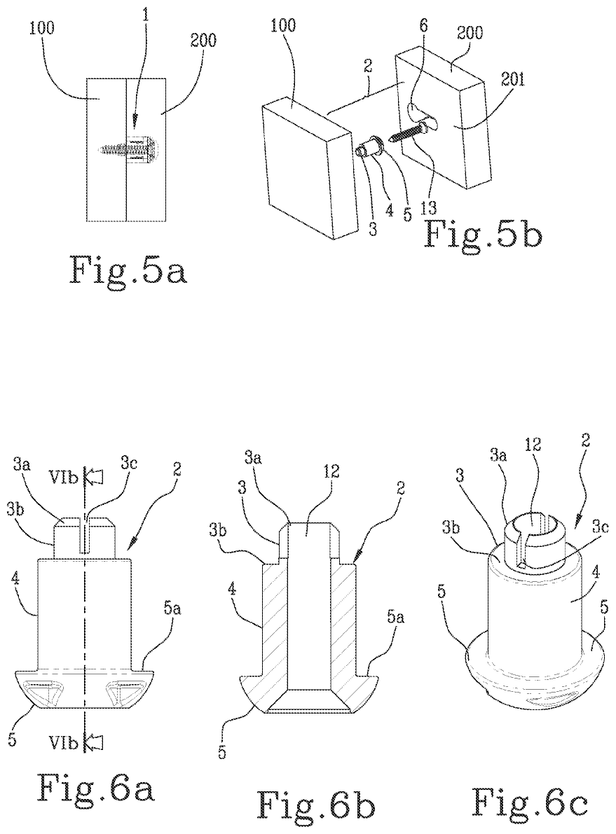

FIGS. 6a-6c show an element of the connecting system in FIG. 1, respectively in plan, in longitudinal section according to the line VIb-VIb in FIG. 4a and in perspective;

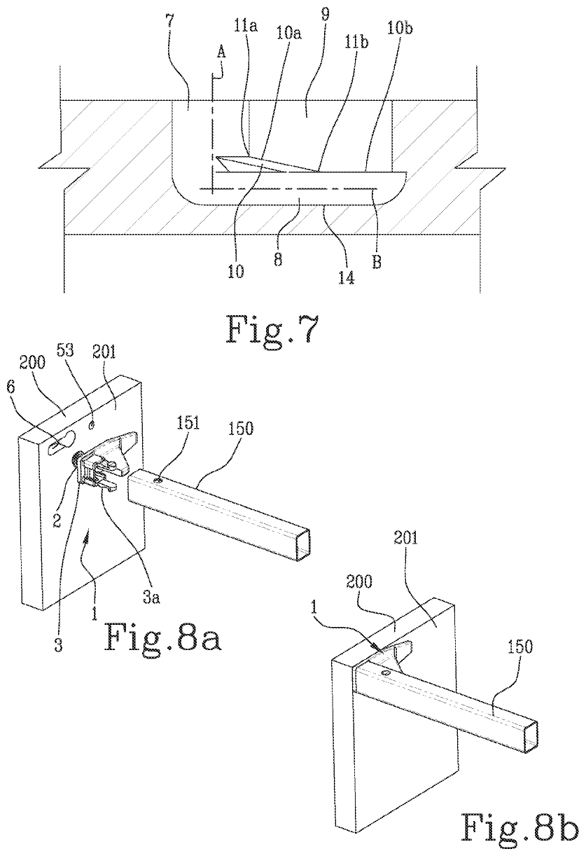

FIG. 7 shows a sectional view of a second element of the connecting system in FIG. 1;

FIGS. 8a and 8b show perspective views, respectively in a disassembled and assembled condition, of a connecting system for components of a piece of furniture according to a fourth embodiment of the present invention;

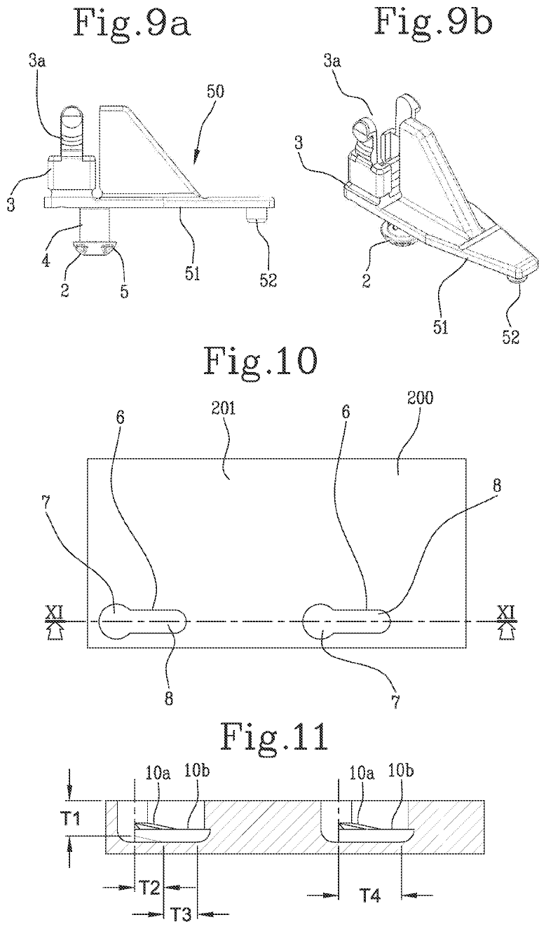

FIGS. 9a and 9b show plan and perspective views, respectively, of an element of the connecting system of FIGS. 8a and 8b;

FIG. 10 shows a component of a piece of furniture processed according to a processing method in accordance with the present invention;

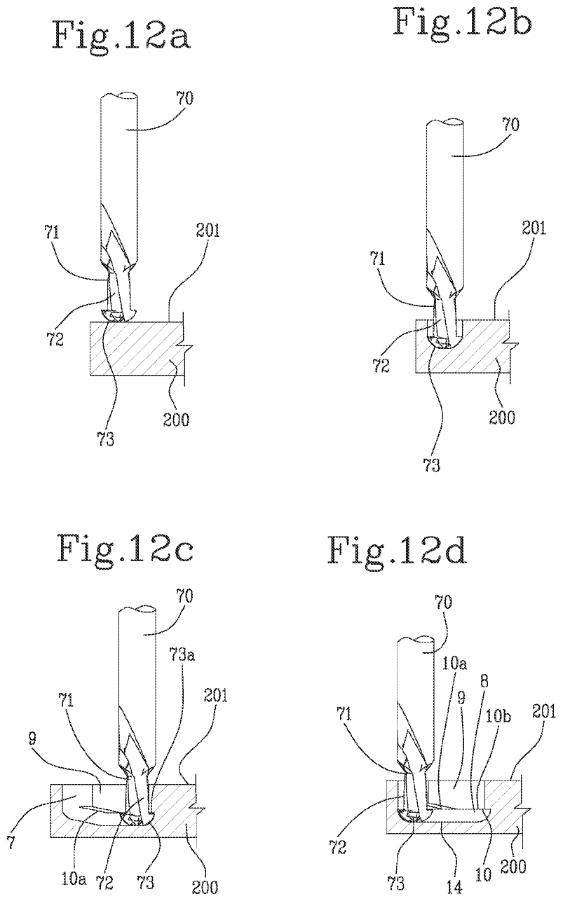

FIG. 11 shows a sectional view according to the section line XI-XI in FIG. 10;

FIGS. 12a-12d show successive processing steps of the processing method of a component of a piece of furniture according to the present invention.

With reference to the appended figures, number 1 indicates a connecting system for components of a piece of furniture according to the present invention.

In particular, the connecting system 1 is configured to connect a first 100, 150 and a second component 200 of a piece of furniture, where the term component is intended to define both structural elements (doors, panels, uprights, crosspieces) and accessory elements of the piece of furniture itself.

In particular, the first component can be defined by both a door or panel 100, possibly wooden, but also by another component such as a bar 150, a crosspiece, a cabinet, etc.

The second component 200 is preferably shaped like a wooden panel, preferably with a structure in MDF, chipboard or veneered.

The connecting system 1 comprises a pin 2 engageable in a slot 6 made in the second component 200 of the piece of furniture.

The pin 2 has a base 3 which is fixable or integrated to the first component 100, 150 of the piece of furniture, a stem 4 departing from said base along a main direction and an enlarged portion 5.

Preferably, the enlarged portion 5 has a width (i.e., diameter) about ⅓ greater with respect to the stem 4.

In the preferred embodiment, the stem has a width (i.e., diameter) of about 8 mm and the enlarged portion has a width (i.e., diameter) of about 12 mm.

The base 3 is preferably engaged and fixed to the first component 100, 150 of the piece of furniture, more preferably reversibly.

In the embodiment shown in FIGS. 1-7, the base 3 preferably comprises an inlet portion 3a insertable into a corresponding seat 101 made in the first component 100.

The inlet portion 3a has a transverse dimension (i.e., section) which is smaller with respect to a body of the base 3.

In particular, the inlet portion 3a protrudes from the base body 3, defining an abutted surface 3b with a face of the first component 100.

In fact, the first component 100 has a flat face 100a on which a hole defining said seat 101 is made.

The pin 2 is positioned on the flat face 100a with the inlet portion 3a inserted into the seat 101 and the abutment surface 3b against the flat face 100a.

In the preferred embodiment, the inlet portion 3a has at least one longitudinal notch 3c which gives it a degree of elasticity such as to facilitate its insertion and maintenance in the seat 101.

Preferably, in order to increase the seal of the connection between the pin 2 and the first component 100, a screw 12 (or other threaded element) is provided which crosses the pin 2 along said insertion direction “A” between the enlarged portion 5 and the inlet portion 3a.

Therefore, the pin 2 has a longitudinal through cavity 13 which houses the screw 12 and allows it to be anchored to a bottom wall of the seat 101.

Preferably, moreover, the enlarged portion 5 has a width greater than that of the stem 4 and defines a shoulder 5a facing the first component 100, in particular the flat face 100a of the first component 100.

Thus, the flat face 100a and the shoulder 5a are separated from each other by the stem 4.

Advantageously, the shoulder 5a defines with the flat face 100a of the first component 100 an undercut useful for anchoring the pin 2 in the slot 6, as will be further clarified in the following.

In the preferred embodiment, the shoulder 5a develops orthogonally to the main direction; more preferably, said shoulder 5a lies in a (geometric) plane parallel to the flat face 100a of the first component 100.

It should be noted that the pin 2 develops along such a main direction which, in use, corresponds to an insertion direction “A” of the pin 2 in the slot 6.

The slot 6 is, as said, made in the second component 200 of the piece of furniture.

Preferably, such a slot 6 is made by drilling a flat face 201 of the second component, preferably by means of special milling tools.

The slot extends along a tightening direction “B” transverse to said insertion direction “A” and is sized to house inside the enlarged portion 5 of the pin 2.

Preferably, the insertion direction “A” and the tightening direction “B” are orthogonal to each other.

Moreover, in the preferred embodiment, the insertion direction “A” is orthogonal to the flat face 201 of the second component 200.

Still preferably, the tightening direction “B” is parallel to the flat face 201 of the second component 200

In the preferred embodiment, the slot 6 has an insertion portion 7 and a retaining portion 8 arranged in succession along the tightening direction “B”.

The insertion portion 7 is provided with an enlarged insertion section such as to allow the introduction of the enlarged portion 5 of the pin 2 into the slot 6 along the insertion direction “A”.

The retaining portion 8, on the other hand, is provided with at least one abutment shoulder 9 (preferably two) extending along the tightening direction “B” and shaped to prevent the exit of the enlarged portion 5 along the insertion direction “A”.

Preferably, there are two abutment shoulders 9 of the slot 6, arranged on the sides thereof and, preferably, facing each other and parallel.

The pin 2 is therefore insertable inserted inside the slot 6 along said insertion direction “A” in correspondence with the insertion portion 7 and, once inserted, is movable inside the slot 6, along the tightening direction “B” up to a tightening position.

Therefore, during assembly, the pin 2 is inserted inside the slot 6 along said insertion direction “A” in correspondence with the insertion portion 7 and subsequently translated inside the slot 6 in the tightening direction “B” until it reaches a tightening position. It should be noted in this regard that what counts is the establishment of a relative movement between the pin 2 and the slot 6 in the tightening direction “B”, whether it is obtained by moving the pin 2 only, the slot 6 only (i.e., the second component 200) or both.

Therefore, with the system assembled, the enlarged portion 5 of the pin 2 is placed in the slot 6 in correspondence with the tightening position.

The slot 6 therefore has a substantially keyhole slot shape, such as to allow the insertion of the pin 2 in a predetermined first position (i.e., aligned with the insertion direction “A”) and to prevent the exit thereof along the insertion direction “A” in one or more second positions (e.g., tightening position).

In other words, the slot 6 has:
an “outer” portion with variable cross-section between an enlarged portion corresponding to the insertion portion and a narrow portion corresponding to the retaining portion
an “inner”, deeper portion having a substantially constant width and approximately corresponding to that of said enlarged portion of the pin.

Preferably, the “inner” portion has a width (i.e., a dimension orthogonal to both the insertion “A” and tightening “B” directions) which is substantially constant and corresponds to the width (or the diameter of the enlarged portion 5 of the pin 2).

The “outer” portion has a first section, in correspondence with the insertion portion 7, having a width (preferably diameter) substantially corresponding to that of the enlarged portion 5 of the pin 2 and a second section, in correspondence with the retaining portion 8, having a width substantially corresponding to that of the stem 4 of the pin 2.

Therefore, the width of the first section is preferably about ⅓ greater with respect to that of the second section.

In the preferred embodiment, the second section has a width of about 8 mm and the first section has a width of about 12 mm.

According to an aspect of the invention, the abutment shoulder 9 comprises a sliding surface 10 adapted to allow the sliding (or slipping) of the shoulder 5a of the enlarged portion 5 of the pin 2.

The sliding surface 10 preferably has a guide section 10a and a fixing section 10b arranged in succession along the tightening direction “B”.

Thus, such a sliding surface 10 substantially defines an interface between the “outer” portion and the “inner” portion of the slot in correspondence with the retaining portion.

Advantageously, this allows to progressively tighten the pin 2 inside the guide section 10a, significantly increasing the coupling tolerance of the system 1.

Preferably, the guide section 10a is proximal to the insertion portion 7 of the slot 6 and defines an angle with both the insertion direction “A” and the tightening direction “B”.

The fixing section 10b, on the other hand, is distal to the insertion portion 7 and substantially aligned with said tightening direction “B”.

Thus, with reference to the tightening direction “B”, the guide section 10a is interposed between the insertion portion 7 and the fixing section 10b.

Advantageously, thereby, the guide section 10a makes the passage from the insertion direction “A” to the tightening direction “B” fluid and progressive.

More precisely, the guide section 10a of the sliding surface 10 extends between a first end 11a, proximal to said insertion portion 7, and a second end 11b, distal from the insertion portion 7.

Preferably, therefore, the first end 11a is located in correspondence with (next to) the insertion portion 7, while the second end 11b is located near or in any case close to the fixing section 10b.

Preferably, the abutment shoulder 9 (i.e., each abutment shoulder 9) has an increasing thickness between a first value, in correspondence with said first end 11a of the guide section 10a, and a second value, in correspondence with said second end 11b of the guide section 10a.

It should be noted that the term “thickness” is intended to define the dimension from the abutment shoulder 9 evaluated as the distance between the flat face 201 of the component 200 and the sliding surface 10 along the insertion direction “A”.

Advantageously, therefore, the guide section 10a is defined by a ramp descending inside the slot 6 and followed by the enlarged portion of the pin 2 during the sliding along the tightening direction “B”.

Preferably, the guide section 10a of the sliding surface 10 forms an angle between 10° and 30°, preferably about 15°, with said bottom wall 14.

The slot 6 also has a bottom wall 14 extending along the tightening direction “B”, preferably along the entire development of the slot 6 itself.

It should be noted that the sliding surface 10 of each abutment shoulder 9 faces the bottom wall 14.

Preferably, said bottom wall 14 is arranged at a first and a second distance from the first 11a and the second end 11b of the guide section 10a, respectively, in which the first distance is greater than said second distance.

Advantageously, in correspondence with the guide section 10a, the bottom wall 14 does not follow the trend of the guide section 10a itself, but has a different orientation which allows the slot 6 to define an increased space near the insertion portion 7 which, during disassembly, facilitates the extraction of the pin 2.

In correspondence with the fixing section 10b, on the other hand, the abutment shoulder 9 (i.e., the shoulders) has a substantially constant thickness, preferably corresponding (or counter-shaped) to the length of the stem 4 of the pin 2 along the main direction thereof (i.e., along the insertion direction “A”).

Advantageously, thereby, the sealing of the coupling is ensured and, by virtue of the absence of inclined surfaces in correspondence with the tightening position of the pin 2, there is no risk of accidental retroversion.

According to a further aspect of the invention, complementary or alternative to those described heretofore, the connecting system 1 comprises an anti-sliding device 50 configured to prevent the sliding of the pin 2 inside the slot 6 when in the tightening position.

In other words, preferably the system has an additional element with respect to the mere conformation of the slot 6 (and of the pin 2) which ensures the seal of the coupling.

As already mentioned in the introductory portion of the text, this allows to expand the range of applications of the system, making it effective and safe also in single pin couplings, illustrated in an exemplary manner in the embodiments of FIG. 8a-8b in which the first component is a transverse bar 150.

Preferably, the anti-sliding device 50 comprises a blocking element 52 connected to the base 3 of the pin 2 and shaped to engage in a hole 53 (or in the insertion portion 7 of the slot 6) of said second component 200 when the pin 2 is in the tightening position.

In other words, the blocking element 52 is configured to remain in an inactive (or resting) condition in all the positions of the pin 2 except the tightening position, at which the blocking element 52 engages in the hole 53 (or the insertion portion 7 of the slot 6) preventing the further sliding of the pin 2 in the tightening direction “B”.

Therefore, the blocking element 52 comprises a protruding body next to the pin 2, which is protruding along a direction parallel or at least partially parallel to the insertion direction.

Preferably, the blocking element 52 is defined by a tooth 52a protruding from the base 3 and provided with at least one abutment side orthogonal to the tightening direction “B” in order to prevent the movement of the pin 2 along said direction when the tooth 52a is engaged in said hole 53 (or in said insertion portion 7 of the slot 6).

In order to facilitate the movement of the pin 2 and the blocking element 52, the anti-sliding device 50 comprises an elastically deformable bracket 51 (or flap) connecting the base 3 of the pin 2 and the blocking element 52 to one another.

Such a bracket 51 is therefore an elastic body preferably developing in a plane substantially parallel to the sliding direction “B” (more preferably parallel to the flat face 201) and elastically deformable in rotation/flexion around an axis lying in the development plane thereof.

In fact, preferably, the bracket 51 is configured to allow an oscillation of the blocking element 52, with respect to the pin 2, around an axis orthogonal to the insertion direction “A”.

Thereby, following the insertion of the pin 2 into the slot 6, the bracket 51 is inflected, keeping the blocking element 52 pressed against the flat face 201 of the second component until the tightening position is reached by the pin 2, at which point the elastic return action of the bracket 51 pushes the blocking element 52 into the respective hole 53 (or into the insertion portion 7 of the slot 6, depending on the embodiment).

In the illustrated embodiment, in fact, the second component 200 of the piece of furniture has an additional and flanked hole 53 with respect to the slot 6 and the blocking element 52 is shaped to engage in said hole 53.

Alternatively, however, the blocking element 52 could engage directly in the insertion portion 7 of the slot 6, avoiding the need for further perforations of the second component 200.

Preferably, the slot 6 defines therein a stroke of the pin 2 along the tightening direction “B” corresponding to a distance between a central axis of the insertion portion 7 (i.e., the insertion direction “A”) and the main direction of the pin 2 in the tightening position “B”. Such a stroke is considered an interaxis of the slot 6.

Preferably, the central direction of the pin 2 (i.e., the stem 4) is located at a distance from a central axis of the blocking element 52 which is greater than or equal to said stroke (i.e., greater than or equal to the interaxis).

Preferably, however, in order to maximize the seal, the central main direction of the pin 2 is aligned with the central axis of the blocking element 52 along the tightening direction “B”. In other words, with reference to the tightening direction “B”, the blocking element 52 and the pin are aligned.

In such an embodiment, the insertion portion 7 of the slot 6 is interposed between said sliding portion 8 and said hole 53.

Thereby, the action counteracting the sliding of the pin 2 in the slot would be maximized, as it lacks any rotational component.

A further aspect of the present invention, complementary or alternative to the above, relates to a method for processing a component 200 of a piece of furniture.

It should be noted that, for all the method steps below, where the illustrated features refer to structural features of the piece of furniture or of the connecting system 1 mentioned above, what is reported above is to be considered applicable mutatis mutandis.

In particular, the processing method object of the present invention is preferably, but not exclusively, to be considered feasible for the processing of a second component 200 of the piece of furniture described above.

Therefore, although without any limiting intent as described below, the numbering of the component used so far to indicate the second component 200 of the piece of furniture and the relative slot 6 will be maintained.

Preferably, therefore, the second component is a wooden panel, more preferably with a structure in chipboard, MDF or laminate.

The method first includes arranging a component 200 of a piece of furniture having a flat face 201.

It is included to use a milling tool 70 provided with a cutting head 71 having a shaft 72 and an end portion 73 which is wider than said shaft 72 to define a shoulder 73a.

The dimensions of the cutting head 71 correspond to those of the pin 2 and the slot 6 described above, as will be clearer in the following.

In fact, the method according to the invention includes moving the milling tool 70 along a (predetermined) processing path to make a slot 6 in the flat face 201 of the component 200.

In particular, the processing path comprises at least a first “T1”, a second “T2” and a third section “T3”.

The first section “T1” is transverse, preferably orthogonal, to said flat face 201.

In said first section “T1” the milling tool 70 pierces the flat face 201 of the component 200 along a drilling axis “A” up to a first working position in which said end portion 73 is positioned at a first depth. The drilling axis “A” preferably corresponds to the insertion direction “A” described above.

Preferably, therefore, the first section “T1” is substantially a drilling section.

It should be noted that in the first working position the milling tool 70 penetrates inside the component 200 with the end portion 73 and at least a part of the shaft 72.

The second section “T2” includes that the milling tool 70 moves to a second working position along a direction transverse to the first section “T1”.

In this second working position, the end portion 73 of the cutting head 71 is misaligned with respect to said drilling axis “A” and placed at a second depth, greater than the first depth.

Preferably, the movement direction of the second section is inclined with respect to the drilling direction “A” of an angle such as to create, in the slot, an inclined surface with respect to the flat face 201; such an inclined surface preferably corresponds to the guide section 10a of the abutment shoulder 9 described above.

Said inclination is preferably comprised between 10° and 30°, more preferably about 15°.

Therefore, in the preferred embodiment the second section “T2” is substantially straight, but in alternative embodiments it could be curved, preferably with concavity facing the flat face 201.

The third section “T3” is also transverse to the first section “T1”. Along such a third section “T3” the milling tool 70 further translates to a third working position in which the end portion 73 is distal from the first working position with respect to the second working position.

In the third section “T3” the tool moves along a direction partly aligned with that of the second section “T2” along a direction corresponding to the tightening direction “B” described with reference to the connecting system 1.

Preferably, the third section “T3” is inclined with respect to the second section “T2”, more preferably parallel to the flat face 201.

In fact, in the preferred embodiment the third working position is offset from the second working position but is at the same second depth.

Preferably, moreover, the method includes moving the milling tool 70 along a fourth section “T4” in which said milling tool 70 moves from the third working position to a fourth working position.

In the fourth working position the end portion 73 of the cutting head 71 is aligned with said drilling axis “A” and is positioned at said second depth.

Advantageously, thereby, the section of the slot 6 is enlarged in correspondence with the insertion portion 7, facilitating the exit of the pin 2 referred to in the connecting system 1 during disassembly.

Advantageously, therefore, by virtue of the processing method according to the invention it is possible to make a slot 6 having the technical and geometric features described above with reference to the connecting system 1.

In this regard, such a method can be used within the creation of a connecting system 1 between two components of a piece of furniture of the type described above, in which the above steps are provided together with the creation of a pin 2 and the fixing of said pin 2 to a first component 100, 150.

The invention achieves the intended objects and offers important advantages.

In fact, the use of a sliding connecting system which has a guide section such as the one claimed makes the tightening of the coupling progressive, facilitating movements and giving a greater dimensional tolerance to the assembly.

Moreover, the method of making the slot is particularly efficient in the processing of wooden panels, for example in MDF, chipboard or laminate, effectively eliminating the need for inserts which increase production and packaging costs.

Furthermore, the presence of an anti-sliding device greatly increases the reliability of the system, greatly expanding its scope of application.

1. A connecting system between components of a piece of furniture, comprising:
a pin having
a base that can be attached or integrated to a first component of a piece of furniture,
a stem departing from said base along an insertion direction and
at least an enlarged portion having a width greater than said stem;
a slot made in a second component of a piece of furniture, developing along a tightening direction transverse to said insertion direction and sized to house inside said enlarged portion of the pin, wherein the slot has an insertion portion equipped with an enlarged insertion section such as to allow the introduction of the enlarged portion of the pin in the slot along said insertion direction and a retaining portion, provided with at least one abutment shoulder which extends along said tightening direction and is shaped to prevent said enlarged portion from coming out along the insertion direction;
wherein said pin can be inserted inside said slot along said insertion direction in correspondence with said insertion portion and is movable inside the slot, along the tightening direction, towards a tightening position,
wherein it includes an anti-sliding device configured to prevent the sliding of the pin inside the slot when it is in the tightening position.

2. The connecting system according to claim 1, wherein the anti-sliding device comprises a blocking element connected to said base of the pin and protruding next to said pin; said blocking element being shaped to engage in a hole or in the insertion portion of the slot of said second component when said pin is in the tightening position.

3. The connecting system according to claim 2, comprising an elastically deformable bracket which connects said base of the pin and said blocking element.

4. The connecting system according to claim 2, wherein said elastically deformable bracket is configured to allow oscillation of the blocking element, with respect to the pin, around an axis orthogonal to the direction of insertion.

5. The connecting system according to claim 2, wherein a central axis of the pin is aligned with a central axis of the blocking element along the tightening direction.

6. The connecting system according to claim 2, wherein said slot internally defines a stroke of the pin along the tightening direction corresponding to a distance between an axis central of the insertion portion and a central axis of the pin in the tightening position; said central axis of the pin being located at a distance from a central axis of the blocking element greater than said stroke.

7. The connecting system according to claim 6, wherein said hole made in the second component of the furniture is placed side by side with the slot; said blocking element being shaped to engage in said hole.

8. The connecting system according to claim 7, wherein said hole is aligned with the slot along the tightening direction, wherein said insertion portion of the slot is interposed between said portion of sliding and said hole.

9. The connecting system according to claim 2, wherein said blocking element is defined by a tooth protruding from the bracket and provided with at least one flank orthogonal to the tightening direction in order to prevent the movement of the pin when engaged in said hole or in said insertion portion of the slot.

10. A piece of furniture, comprising:
a first component;
a second component having a flat face;
wherein it comprises a connecting system between said first and said second component having the characteristics of claim 1, wherein said pin is fixed to said first component, said slot it is made of said second component and the enlarged portion of the pin is placed in the slot in correspondence with the tightening position.
